(19) United States
(12) Patent Application Publication
(10) Pub. No.: US 2025/0358048 A1
(43) Pub. Date: Nov. 20, 2025

(54) TRIANGULAR INTERLEAVER FOR FREQUENCY DOMAIN DIVERSITY

(71) Applicant: QUALCOMM Incorporated, San Diego, CA (US)

(72) Inventors: Somsubhra BARIK, San Diego, CA (US); Jing SUN, San Diego, CA (US); Wei YANG, San Diego, CA (US)

(21) Appl. No.: 18/665,421

(22) Filed: May 15, 2024

(51) Int. Cl. H04L 1/00; H04W 72/23

(52) U.S. Cl. CPC H04L 1/0071; H04W 72/23

(57) ABSTRACT

Methods, systems, and devices for wireless communications are described. A device may use a triangular interleaver to improve a frequency domain diversity of a signal compared to a rectangular interleaver. For example, the device may generate a transport block (TB) including multiple symbols, the multiple symbols including modulated and precoded symbols. After generating the TB, the device may interleave a first set of resource blocks to a second set of resource blocks in a frequency domain by mapping the first set of resource blocks to the second set of resource blocks according to a triangular matrix for one or more of the multiple symbols. The first set of resource blocks may include virtual resource blocks (VRBs), and the second set of resource blocks may include physical resource blocks (PRBs). The device may transmit the TB based on the interleaving.

### FIELD OF TECHNOLOGY

The following relates to wireless communications, including a triangular interleaver for frequency domain diversity.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a wireless communication device is described. The method may include generating a transport block (TB) including a set of multiple symbols, the set of multiple symbols including modulated and precoded symbols, interleaving a first set of resource blocks to a second set of resource blocks in a frequency domain by mapping the first set of resource blocks to the second set of resource blocks according to a triangular matrix for one or more of the set of multiple symbols, where the first set of resource blocks includes one or more virtual resource blocks (VRBs), and where the second set of resource blocks includes one or more physical resource blocks (PRBs), and transmitting the TB based on the interleaving.

A wireless communication device for wireless communications is described. The wireless communication device may include one or more memories storing processor executable code, and one or more processors coupled with the one or more memories. The one or more processors may individually or collectively be operable to execute the code to cause the wireless communication device to generate a TB including a set of multiple symbols, the set of multiple symbols including modulated and precoded symbols, interleave a first set of resource blocks to a second set of resource blocks in a frequency domain by mapping the first set of resource blocks to the second set of resource blocks according to a triangular matrix for one or more of the set of multiple symbols, where the first set of resource blocks includes one or more VRBs, and where the second set of resource blocks includes one or more PRBs, and transmit the TB based on the interleaving.

Another wireless communication device for wireless communications is described. The wireless communication device may include means for generating a TB including a set of multiple symbols, the set of multiple symbols including modulated and precoded symbols, means for interleaving a first set of resource blocks to a second set of resource blocks in a frequency domain by mapping the first set of resource blocks to the second set of resource blocks according to a triangular matrix for one or more of the set of multiple symbols, where the first set of resource blocks includes one or more VRBs, and where the second set of resource blocks includes one or more PRBs, and means for transmitting the TB based on the interleaving.

A non-transitory computer-readable medium storing code for wireless communications is described. The code may include instructions executable by one or more processors to generate a TB including a set of multiple symbols, the set of multiple symbols including modulated and precoded symbols, interleave a first set of resource blocks to a second set of resource blocks in a frequency domain by mapping the first set of resource blocks to the second set of resource blocks according to a triangular matrix for one or more of the set of multiple symbols, where the first set of resource blocks includes one or more VRBs, and where the second set of resource blocks includes one or more PRBs, and transmit the TB based on the interleaving.

In some examples of the method, wireless communication devices, and non-transitory computer-readable medium described herein, a first resource block in a first row of a set of multiple rows of the second set of resource blocks may be offset from a second resource block adjacent to the first resource block in the first row by a first quantity of resource blocks, and the second resource block in the first row may be offset from a third resource block adjacent to the second resource block in the first row by a second quantity of resource blocks, where the first quantity of resource blocks may be different from the second quantity of resource blocks.

In some examples of the method, wireless communication devices, and non-transitory computer-readable medium described herein, one or more first rows of a set of multiple rows of the triangular matrix may be associated with a first length, and one or more second rows of the set of multiple rows of the triangular matrix may be associated with a second length different from the first length.

In some examples of the method, wireless communication devices, and non-transitory computer-readable medium described herein, interleaving the first set of resource blocks to the second set of resource blocks may include operations, features, means, or instructions for interleaving the first set of resource blocks to the second set of resource blocks according to the triangular matrix and a write-read order.

In some examples of the method, wireless communication devices, and non-transitory computer-readable medium described herein, the triangular matrix may be associated with an orientation, the orientation indicative of a direction of a diagonal edge of the triangular matrix.

In some examples of the method, wireless communication devices, and non-transitory computer-readable medium described herein, the orientation may be associated with a write-read order, a read-write order, or both.

Some examples of the method, wireless communication devices, and non-transitory computer-readable medium described herein may further include operations, features, means, or instructions for selecting a length of the triangular matrix, where the length satisfies a threshold quantity of resource blocks according to a first equation, the threshold quantity of resource blocks based on the second set of resource blocks and selecting a width of the triangular matrix, where the width satisfies the threshold quantity of resource blocks according to a second equation, and where the triangular matrix may be geometrically defined via the selected length and the selected width.

Some examples of the method, wireless communication devices, and non-transitory computer-readable medium described herein may further include operations, features, means, or instructions for transmitting a message indicating a read-write order associated with the TB based on the triangular matrix, the read-write order associated with a diagonal alignment of the triangular matrix.

Some examples of the method, wireless communication devices, and non-transitory computer-readable medium described herein may further include operations, features, means, or instructions for transmitting a message indicating that the triangular matrix may be used to interleave the first set of resource blocks to the second set of resource blocks in the frequency domain for one or more symbols of a set of multiple symbols including the TB.

In some examples of the method, wireless communication devices, and non-transitory computer-readable medium described herein, the message includes one of a downlink control information (DCI) message or a radio resource control (RRC) message.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 and 2 show examples of wireless communications systems that support triangular interleavers for frequency domain diversity in accordance with one or more aspects of the present disclosure.

FIGS. 3A through 3C show examples of triangular interleavers that support triangular interleaving for frequency domain diversity in accordance with one or more aspects of the present disclosure.

FIG. 4 show examples of triangular interleavers that support triangular interleaving for frequency domain diversity in accordance with one or more aspects of the present disclosure.

FIG. 5 shows an example of a process flow that supports a triangular interleaver for frequency domain diversity in accordance with one or more aspects of the present disclosure.

FIGS. 6 and 7 show block diagrams of devices that support triangular interleavers for frequency domain diversity in accordance with one or more aspects of the present disclosure.

FIG. 8 shows a block diagram of a communications manager that supports a triangular interleaver for frequency domain diversity in accordance with one or more aspects of the present disclosure.

FIG. 9 shows a diagram of a system including a device that supports a triangular interleaver for frequency domain diversity in accordance with one or more aspects of the present disclosure.

FIGS. 10 and 11 show flowcharts illustrating methods that support triangular interleavers for frequency domain diversity in accordance with one or more aspects of the present disclosure.

### DETAILED DESCRIPTION

A device (e.g., a network entity, a UE, and/or a base station) may interleave a first set of resource blocks to a second set of resource blocks according to an interleaving matrix. For example, the device may perform virtual resource block (VRB)-to-physical resource block (PRB) interleaving according to a block interleaver (e.g., a rectangular interleaver). The device may interleave each code block across a cluster of resource blocks, where each cluster is separated by a uniform distance. In other words, the device may interleave each code block across a column of PRBs separated by a uniform distance in a frequency domain. In some cases, a depth of the block interleaver, such as the quantity of columns, may coincide with a channel periodicity. In cases in which the interleaver depth coincides with the channel periodicity, the device may experience reduced performance due to a uniform spread of the code block in the frequency domain.

As described herein, the device may interleave the first set of resource blocks to the second set of resource blocks according to a triangular interleaving matrix. The device may interleave each code block over a cluster of resource blocks, where at least some of the clusters may be separated by a non-uniform distance in the frequency domain. For example, because each column, or at least some columns, of the triangular interleaving matrix may have different amounts of resource blocks, the code block may be spread non-uniformly in the frequency domain. The device may improve a performance in accordance with interleaving using the triangular interleaving matrix based on the non-uniform spread of the code blocks in the frequency domain compared to the uniform spread associated with use of the block interleaving matrix.

Aspects of the disclosure are initially described in the context of wireless communications systems. Aspects of the disclosure are also described in the context of triangular interleavers and process flows. Aspects of the disclosure are further illustrated by and described with reference to apparatus diagrams, system diagrams, and flowcharts that relate to triangular interleaver for frequency domain diversity.

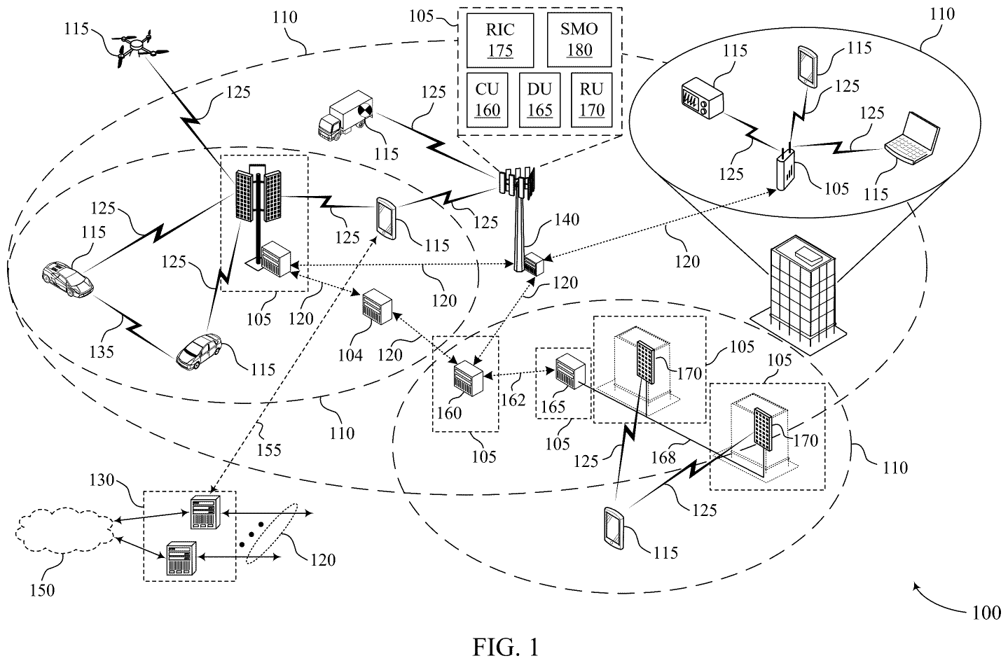

FIG. 1 shows an example of a wireless communications system 100 that supports triangular interleaver for frequency domain diversity in accordance with one or more aspects of the present disclosure. The wireless communications system 100 may include one or more devices, such as one or more network devices (e.g., network entities 105), one or more UEs 115, and a core network 130. In some examples, the wireless communications system 100 may be an LTE network, an LTE-A network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

As described herein, a device, such as the network entity 105 or the UE 115, may interleave a first set of resource blocks to a second set of resource blocks in accordance with a triangular interleaving matrix. For example, the network entity 105 or the UE 115 may perform VRB-to-PRB mapping using the triangular interleaving matrix rather than a rectangular or block interleaving matrix. The triangular interleaving matrix may be associated with a non-uniform spread of code blocks across a frequency domain. For example, because columns of the triangular interleaving matrix have a non-uniform length, a frequency domain separation between code blocks across the columns may be non-uniform. In some examples, the triangular interleaving matrix may be associated with improved frequency domain diversity compared to a frequency domain diversity associated with the rectangular or block interleaving matrix. For example, the triangular interleaving matrix may produce the non-uniform spread in the frequency domain, while the rectangular or block interleaving matrix may produce a uniform spread in the frequency domain.

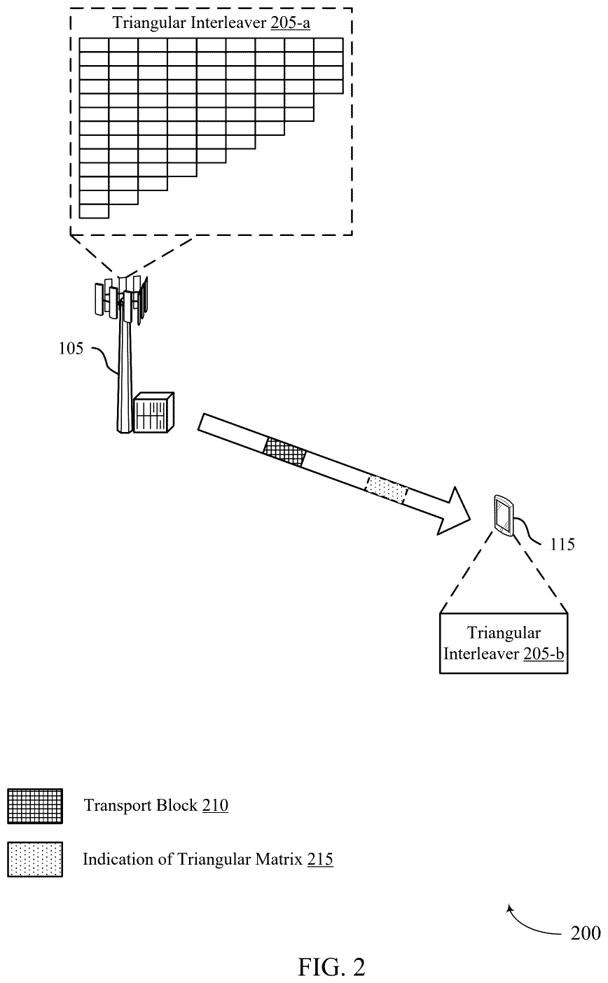

FIG. 2 shows an example of a wireless communications system 200 that supports triangular interleaver for frequency domain diversity in accordance with one or more aspects of the present disclosure. The wireless communications system 200 may implement or be implemented by various aspects of the wireless communications system 100. For example, the wireless communications system 200 may include a network entity 105 and a UE 115, which may be examples of the network entity 105 and the UE 115, respectively, as described with reference to FIG. 1.

The wireless communications system 200 may support a triangular interleaver for frequency domain diversity at the network entity 105 and the UE 115, where the network entity 105 and the UE 115 may use a triangular interleaving matrix to perform VRB-to-PRB interleaving. For example, the network entity 105 may use a triangular interleaver 205-a, the UE 115 may use a triangular interleaver 205-b, or both. In the example of FIG. 2, the network entity 105 may use the triangular interleaver 205-a prior to transmission of a transport block (TB) 210 to the UE 115. However, it may be understood that in other examples, the UE 115 may use the triangular interleaver 205-b for an uplink transmission, such as for a transmission to the network entity 105.

The network entity 105, the UE 115, or both may use the triangular interleaver 205-a and the triangular interleaver 205-b, respectively, to improve a spread of a TB in a frequency domain compared to a rectangular or block interleaving matrix. For example, the rectangular or block interleaving matrix may be defined by a parameter R, which may denote a quantity of columns in the rectangular or block interleaving matrix. Accordingly, each code block of a TB may be interleaved across clusters with a uniform inter-cluster frequency domain separation of R resource block bundles. Regularity in inter-cluster distance may increase a susceptibility to performance loss in examples in which a channel periodicity coincides with cluster separation. Alternatively, the network entity 105, the UE 115, or both may use a triangular matrix (e.g., the triangular interleaver 205-a or the triangular interleaver 205-b). By using the triangular matrix, a quantity of non-contiguous clusters over which code blocks are spread in the frequency domain may vary from code block-to-code block. As an example, for a read-write order of row-in, column-out, output indices of an 8×10 block interleaver with 80 resource block bundles may be {1, 11, 21, 31, 41, . . . , 60, 70, 80}, whereas output indices of a triangular interleaver with the 80 resource block bundles may be {1, 14, 26, 37, 47, . . . , 12, 25, 13}.

The network entity 105 may generate the TB 210. For example, the network entity 105 may perform a transport process in which data is prepared for transport. The transport process may be an example of a physical downlink shared channel (PDSCH) transport process. In the transport process, the network entity 105 may perform one or more of: data identification, TB CRC attachment, low-density parity check (LDPC) base graph selection, code block segmentation and code block CRC attachment, channel coding, rate matching, code block concatenation, scrambling, modulation, layer mapping, antenna port mapping, mapping to VRB, and mapping from VRB to PRB. The network entity 105 may perform one or more operations of the transport process to convert data into a format transmissible on a channel, such as a PDSCH, and transmit the formatted data via transmission antenna of the network entity 105. For example, the network entity 105 may generate the TB 210 including multiple symbols, which may be modulated and precoded according to one or more operations of the transport process. After generating the TB 210, the network entity 105 may use the triangular interleaver 205-a during mapping from VRB to PRB in the transport process.

During the mapping from VRB to PRB, the network entity 105 may interleave a first set of resource blocks (e.g., VRBs) to a second set of resource blocks (e.g., PRBs) in a frequency domain by mapping the first set of resource blocks to the second set of resource blocks according to the triangular interleaver 205-a for one or more of multiple symbols of the TB 210. The triangular interleaver 205-a may be defined as “triangular” by including at least two rows having different lengths. That is, the triangular interleaver 205-a may be a matrix having first rows of a first length and second rows of a second length different than the first length. In some examples, the triangular interleaver 205-a may have rows of all different lengths. That is, the triangular interleaver 205-a may include multiple rows having respective, distinct, lengths.

Based on the triangular interleaver 205-a having the rows with different lengths, resource blocks of a same row or column in the second set of resource blocks (e.g., PRBs) may be offset by different quantities of resource blocks. That is, in a first row or column, a first resource block may be offset from a second, adjacent resource block by a first quantity of resource blocks, and the second resource block may be offset from a third, adjacent resource block by a second quantity of resource blocks different than the first quantity of resource blocks.

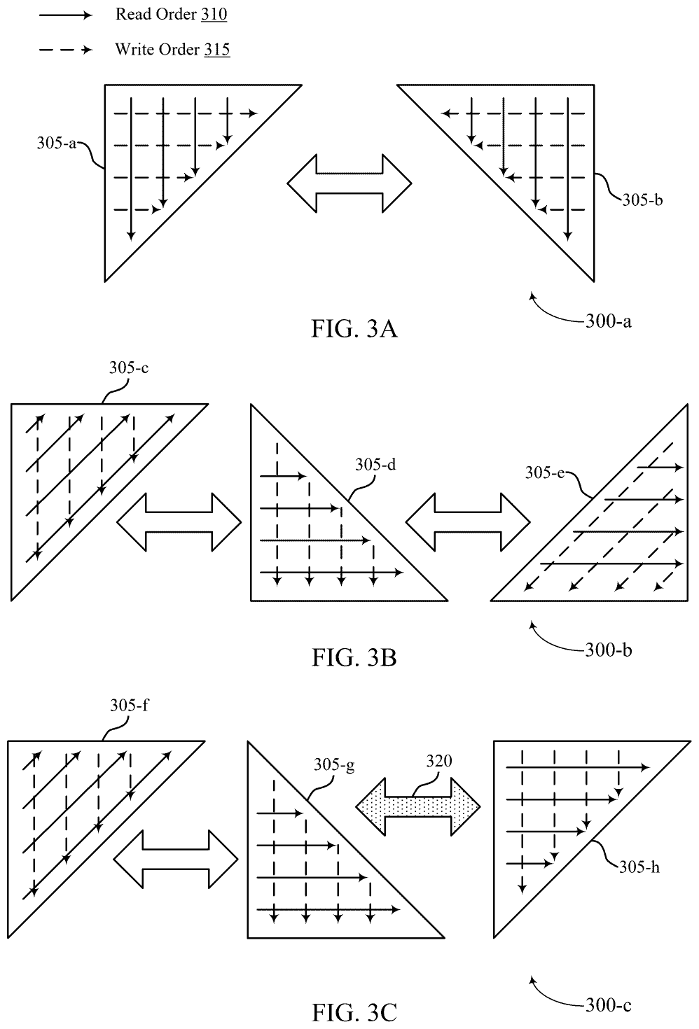

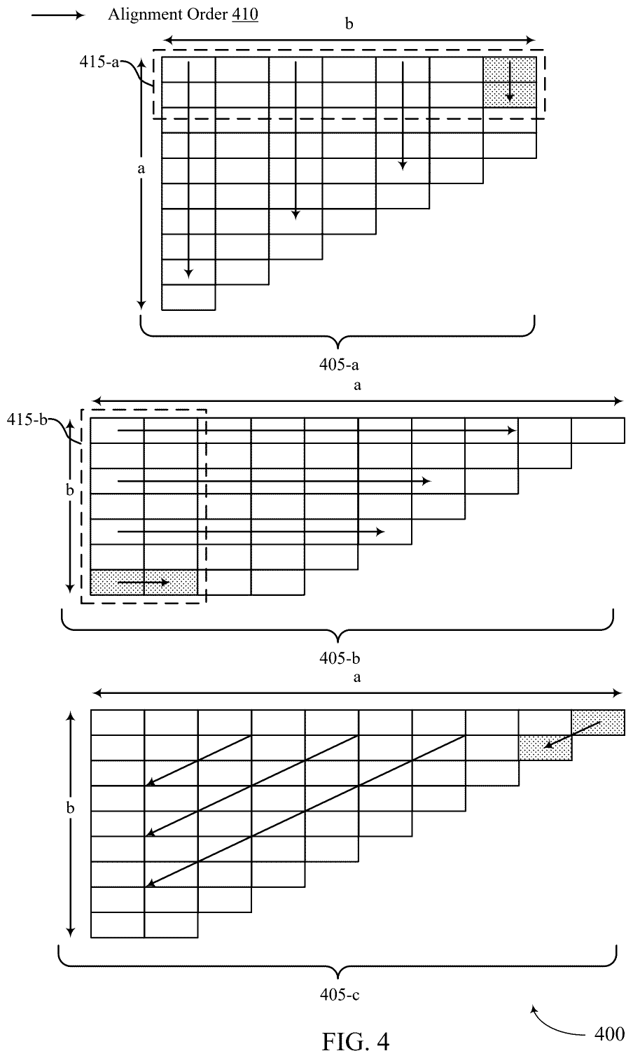

In some examples, the network entity 105 may interleave the first set of resource blocks to the second set of resource blocks according to write-read order, a read-write order, or both. For example, the network entity 105 may write resource blocks in a row-by-row manner and read resource blocks in a column-by-column manner (e.g., row-in, column-out). In some examples, the write-read order or the read-write order may be associated with an orientation of the triangular interleaver 205-a, such as an orientation indicative of a direction of a diagonal edge of the triangular interleaver 205-a. The write-read order, read-write order, and orientation of triangular interleavers may be described in greater detail elsewhere herein, including with reference to FIGS. 3 and 4.

The network entity 105 may transmit an indication of the triangular matrix 215 to the UE 115. For example, the network entity 105 may transmit a message indicating the read-write order associated with the TB 210 based on the triangular interleaver 205-a, where the read-write order is associated with a diagonal alignment of the triangular interleaver 205-a. The diagonal alignment may be described in greater detail elsewhere herein, including with reference to FIG. 4. Additionally, or alternatively, the network entity 105 may transmit a message indicating that the triangular interleaver 205-a is used to interleave the first set of resource blocks to the second set of resource blocks in the frequency domain for one or more symbols of the multiple symbols of the TB 210. The network entity 105 may transmit the indication of the triangular matrix 215 to the UE 115 via a downlink control information (DCI) message or a RRC message. For example, the network entity 105 may transmit a DCI-level indication indicating to the UE 115 of the use of triangular interleaving mechanism via a bit in a DCI field. As an example, in a DCI format (e.g., 1_0 or 1_1), the network entity 105 may include an additional bit in a VRB-to-PRB mapping field. In other words, the network entity 105 may augment a DCI payload. Alternatively, the network entity 105 may include a value in an information element of a RRC message (e.g., vrb-ToPRB-Interleaver in PDSCH-Config) to indicate that the triangular interleaving mechanism may be used for VRB-to-PRB mapping. In some examples, the network entity 105 may include the information element in an additional RRC message (e.g., in addition to n2 and n4).

In the example of FIG. 2, the UE 115 may receive the TB 210, the indication of the triangular matrix 215, or both. In some examples, the UE 115 may deinterleave the TB 210 according to the indication of the triangular matrix 215. For example, the UE 115 may decode the TB 210 based on the triangular matrix. In other words, the UE 115 may deinterleave the second set of resource blocks to the first set of resource blocks according to a reverse read-write order from the interleaving operation performed at the network entity 105, which the UE 115 may determine based on the indication of the triangular matrix 215.

In alternative examples, the UE 115 may generate a TB and perform a physical uplink shared channel (PUSCH) transport process. In the PUSCH transport process, the UE 115 may perform one or more of: data identification, TB CRC attachment, LDPC base graph selection, code block segmentation and code block CRC attachment, channel coding, rate matching, code block concatenation, data and control multiplexing, scrambling, modulation, layer mapping, transform precoding, precoding, mapping to VRB, and mapping from VRB to PRB. The UE 115 may perform one or more operations of the PUSCH transport process to convert data into a format transmissible on a channel, such has PUSCH. The UE 115 may use the triangular interleaver 205-b during mapping from VRB to PRB in the PUSCH transport process. In examples in which the UE 115 generates the TB and uses the triangular interleaver 205-b, the network entity 105 may deinterleave the TB generated by the UE 115 according to a triangular matrix. That is, the network entity 105 may deinterleave a set of PRBs to a set of VRBs according to a reverse read-write order from the interleaving operation performed at the UE 115.

FIG. 3A shows an example of triangular interleavers 300-a that support frequency domain diversity in accordance with one or more aspects of the present disclosure. The triangular interleavers 300-a may implement or be implemented by various aspects of the wireless communications system 100, the wireless communications system 200, or both. For example, the triangular interleavers 300-a may be implemented by a network entity or a UE, which may be examples of the network entity 105 or the UE 115 as described with reference to FIGS. 1 and 2.

A triangular interleaver may be rotated at an arbitrary angle to arrive at an orientation. For example, the orientation may be defined by a direction of a diagonal edge of the triangular interleaver. Two such orientations of triangular interleavers are illustrated in the example of FIG. 3A by a triangular interleaver 305-a and a triangular interleaver 305-b. The triangular interleaver 305-b may be the same as the triangular interleaver 305-a with the exception of an orientation. For example, the triangular interleaver 305-a and the triangular interleaver 305-b may have a same quantity of columns and rows arranged in a same manner. The triangular interleaver 305-a and the triangular interleaver 305-b may be mirror images.

The triangular interleaver 305-a and the triangular interleaver 305-b may have opposite read orders or opposite write orders. For example, the triangular interleaver 305-a and the triangular interleaver 305-b may share a read order (e.g., with a downward direction) but have write orders in opposite directions (e.g., left to right for the triangular interleaver 305-a and right to left for the triangular interleaver 305-b).

The triangular interleaver 305-a and the triangular interleaver 305-b may yield a same interleaving pattern. That is, VRBs mapped to PRBs according to either of the triangular interleaver 305-a or the triangular interleaver 305-b may have a same output. For example, a frequency diversity achieved via the triangular interleaver 305-a may be the same as a frequency diversity achieved via the triangular interleaver 305-b.

FIG. 3B shows an example of triangular interleavers 300-b that support frequency domain diversity in accordance with one or more aspects of the present disclosure. The triangular interleavers 300-b may implement or be implemented by various aspects of the wireless communications system 100, the wireless communications system 200, or both. For example, the triangular interleavers 300-b may be implemented by a network entity or a UE, which may be examples of the network entity 105 or the UE 115 as described with reference to FIGS. 1 and 2.

In some examples, an integer m may exist such

$$N = \frac{m ( m + 1 )}{2} ,$$

where N is a quantity of resource block bundles. In other words, resource block bundles may be arranged (e.g., exactly) in a triangular matrix. Additionally, a combination of orientation of a triangular matrix and a write-read order may yield a same interleaved output sequence as one or more combinations of matrix orientations and read-write orders corresponding to the orientations. Examples of triangular interleavers with different orientations and write-read orders are shown in the example of FIG. 3B, where a triangular interleaver 305-c, a triangular interleaver 305-d, and a triangular interleaver 305-e have different combinations of orientations, read orders 310, and write orders 315, but share a same interleaved output sequence.

FIG. 3C shows an example of triangular interleavers 300-c that support frequency domain diversity in accordance with one or more aspects of the present disclosure. The triangular interleavers 300-c may implement or be implemented by various aspects of the wireless communications system 100, the wireless communications system 200, or both. For example, the triangular interleavers 300-c may be implemented by a network entity or a UE, which may be examples of the network entity 105 or the UE 115 as described with reference to FIGS. 1 and 2.

In some examples, an interleaving performance of triangular interleavers may be statistically independent of the read orders 310, the write orders 315, or both. For example, a triangular interleaver 305-f and a triangular interleaver 305-g may be statistically equivalent 320 to a triangular interleaver 305-h. However, a minimum separation between interleaved entries may not be preserved between the triangular interleaver 305-f or the triangular interleaver 305-g and the statistically equivalent 320 triangular interleaver 305-h.

Different orientations of triangular interleavers may be associated with read orders 310, write orders 315, or both. For example, a network entity in communication with a UE may agree, prior to transmission of a TB, to a direction of writing into and reading off a triangular matrix such that a minimum separation between interleaved indices is maximized. In other words, given a triangular matrix of a certain size, the read order 310, the write order 315, or both are fixed and may not be signaled (e.g., explicitly).

As an example, a minimum separation of output indices of the triangular interleaver 305-g may be 1. An output of the triangular interleaver 305-g, based on the read order 310 and the write order 315, may be {1, 2, 8, 3, 9, 14, 4, 10, 15, 19, . . . , 27, 28} for a quantity of 28 resource blocks. Alternatively, if the write order 315 of the triangular interleaver 305-g is changed to be upwards, the output of the triangular interleaver 305-g may be {1, 8, 14, 19, 23, 26, 28, 2, . . . , 6, 13, 7}, with a minimum separation of 2. In such examples, the device may use the write order 315 which yields the minimum separation of 2 rather than 1.

FIG. 4 shows an example of triangular interleavers 400 that support frequency domain diversity in accordance with one or more aspects of the present disclosure. The triangular interleavers 400 may implement or be implemented by various aspects of the wireless communications system 100, the wireless communications system 200, or both. For example, the triangular interleavers 400 may be implemented by a network entity or a UE, which may be examples of the network entity 105 or the UE 115 as described with reference to FIGS. 1 and 2.

In some examples, there may not be an integer m such that

$$N = \frac{m ( m + 1 )}{2} ,$$

where N is a quantity of resource block bundles. In other words, resource block bundles may not be arranged exactly in a triangular matrix. In such examples, a device (e.g., a network entity 105, a UE 115, and/or a base station 140 as described with reference to FIG. 1) may determine a length of a triangular interleaver, a, and a width of a triangular interleaver, b, according to one or more equations. For example, in examples in which an alignment order 410 is along a non-diagonal side of the triangular interleaver, such as in the example of a triangular interleaver 405-a (e.g., column-wise alignment) or a triangular interleaver 405-b (e.g., row-wise alignment), the device may select a as a smallest integer such that

$$\frac{a ( a + 1 )}{2} \geq N .$$

Additionally, the device may select b as a smallest integer such that

$${\sum }_{i = 0}^{b - 1} ( a - i ) = ( ab - \frac{b ( b - 1 )}{2} ) \geq N ,$$

where b≤a.

In some other examples, such as examples in which the alignment order 410 is along a diagonal size of the triangular interleaver, such as in the example of the triangular interleaver 405-c (e.g., diagonal-wise alignment), the device may select a as a smallest integer such that

$$\frac{a ( a + 1 )}{2} \geq N .$$

Additionally, the device may select b as a smallest integer such that b=a−1.

A performance of triangular interleavers with the alignment order 410 of row-wise alignment or column-wise alignment may be impacted by a regularity of resource block bundles in a rectangular portion of the triangular matrix. For example, in a rectangular portion 415-a or a rectangular portion 415-b, all rows may be associated with a same quantity of columns, or all columns may be associated with a same quantity of rows. A size of the rectangular portion may be defined as

$$( ab - \frac{b ( b - 1 )}{2} - N + 1 ) \times ( b - 1 ) .$$

Based on the rectangular portion 415-a and the rectangular portion 415-b associated with row-wise or column-wise alignment, the device may select the triangular interleaver 405-c constructed using the diagonal-wise alignment. In other words, for a triangular interleaver matrix where ∃ an integer m s.t.

$$N = \frac{m ( m + 1 )}{2} ,$$

the device may select an interleaver constructed using diagonal wise alignment.

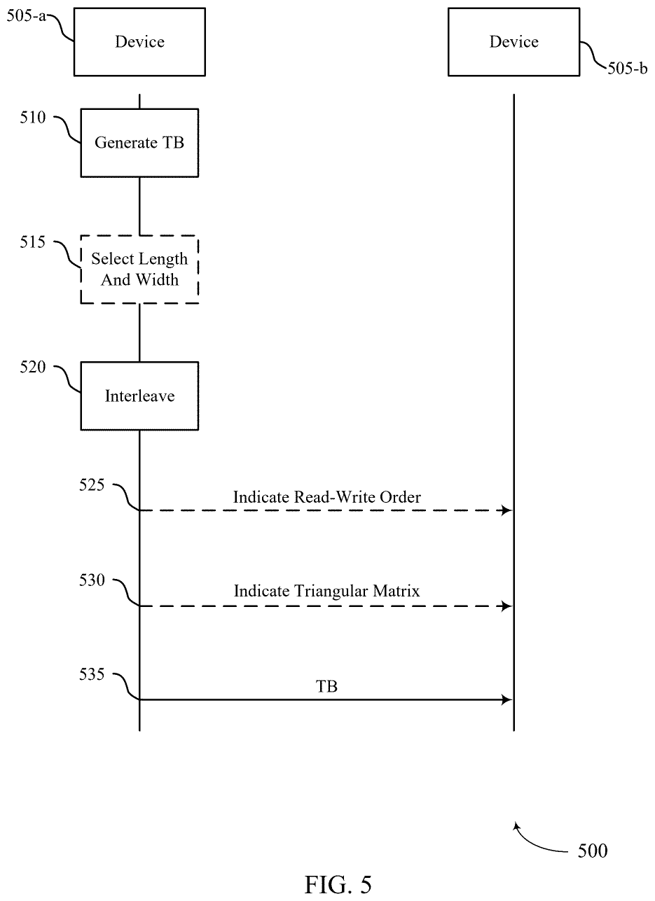

FIG. 5 shows an example of a process flow 500 that supports triangular interleaver for frequency domain diversity in accordance with one or more aspects of the present disclosure. In some examples, the process flow 500 may implement or be implemented by aspects of the wireless communications system 100, the wireless communications system 200, or any of the triangular interleavers 300-a, 300-b, 300-c, or 400. For example, the process flow 500 may include a device 505-a and a device 505-b, which may be examples of corresponding devices as illustrated by and described with reference to FIGS. 1 and 2.

Alternative examples of the following may be implemented. Some operations are performed in a different order than described or are not performed at all. In some cases, operations may include additional features not mentioned below, or further operations may be added. Although the device 505-a and the device 505-b are shown performing the operations of the process flow 500, some aspects of some operations may also be performed by one or more other device s.

At 510, the device 505-a may generate a TB. The TB may be an example of the TB 210 as described with reference to FIG. 2. The TB may include multiple symbols, which may be modulated and precoded. For example, the TB may include symbols modulated and precoded according to one or more operations of a transport process, such as the PDSCH transport process or the PUSCH transport process described with reference to FIG. 2.

At 515, the device 505-a may select a width and length. For example, the device 505-a may select a length (e.g., a) of a triangular matrix, where the length satisfies a threshold quantity of resource blocks according to a first equation. The first equation may be an example of the equation

$$\frac{a ( a + 1 )}{2} \geq N$$

as described with reference to FIG. 4. The threshold quantity of resource blocks may be based on a second set of resource blocks (e.g., PRBs). Additionally, the device 505-a may select a width (e.g., b) of the triangular matrix, where the width satisfies the threshold quantity of resource blocks according to a second equation. The second equation may be an example of the equation

$${\sum }_{i = 0}^{b - 1} ( a - i ) = ( ab - \frac{b ( b - 1 )}{2} ) \geq N ,$$

where b≤a, or the equation b=a−1 as described with reference to FIG. 4.

At 520, the device 505-a may interleave a first set of resource blocks (e.g., VRBs) to the second set of resource blocks (e.g., PRBs). For example, the device 505-a may interleave the first set of resource blocks to the second set of resource blocks in a frequency domain by mapping the first set of resource blocks to the second set of resource blocks according to a triangular matrix for one or more of the multiple symbols of the TB. The triangular matrix may be an example of the triangular interleavers 205, the triangular interleavers 305, or the triangular interleavers 405 as described with reference to FIGS. 2 through 4.

In some examples, in accordance with the interleaving associated with the triangular matrix, a first resource block in a first row of multiple rows of the second set of resource blocks may be offset from a second resource block adjacent to the first resource block in the first row by a first quantity of resource blocks. Additionally, the second resource block in the first row may be offset from a third resource block adjacent to the second resource block in the first row by a second quantity of resource blocks, where the first quantity of resource blocks is different from the second quantity of resource blocks. In other words, the second set of resource blocks may be associated with a non-uniform spread in the frequency domain based on the interleaving associated with the triangular matrix.

Additionally, or alternatively, one or more first rows of multiple rows of the triangular matrix may be associated with a first length, and one or more second rows of the multiple rows of the triangular matrix may be associated with a second length different from the first length. In other words, the triangular matrix may include rows which vary in length. That is, a quantity of columns per row (e.g., or a quantity of rows per column) in the triangular matrix may vary between at least two different rows (e.g., or columns).

In some examples, the device 505-a may interleave the first set of resource blocks to the second set of resource blocks according to the triangular matrix and a write-read order. For example, the triangular matrix may be associated with an orientation indicative of a direction of a diagonal edge of the triangular matrix. The orientation may be associated with a write-read order, a read-write order, or both. For example, there may be write-read orders that maximize a minimum separation between interleaved indices for different orientations, such as the different orientations described with reference to FIG. 3B. The device 505-a may not signal (e.g., explicitly) the write-read order to the device 505-b, as the associated write-read order with optimal separation is known.

At 525, the device 505-a may indicate the read-write order to the device 505-b. For example, the device 505-a may transmit (e.g., output) a message indicating the read-write order associated with the TB based on the triangular matrix, where the read-write order is associated with a diagonal alignment of the triangular matrix. That is, in examples in which the triangular matrix is not exactly triangular, such as in the example of FIG. 4, the device 505-a may indicate a read write order associated with diagonal-wise alignment.

At 530, the device 505-a may indicate the triangular matrix to the device 505-b. For example, the device 505-a may transmit (e.g., output) a message indicating that the triangular matrix is used to interleave the first set of resource blocks to the second set of resource blocks in the frequency domain for one or more symbols of the plurality of symbols of the TB.

In the example of FIG. 5, the device 505-b may receive the TB. In some examples, the device 505-b may deinterleave the TB according to the indication of the triangular matrix received at 530. In other words, the device 505-b may deinterleave the second set of resource blocks to the first set of resource blocks according to a reverse read-write order from the interleaving operation performed at the device 505-a at 520, which the device 505-b may determine based on the indication of the triangular matrix received at 530.

In alternative examples, the device 505-b may generate a TB, use a triangular interleaving matrix, or both. For example, the device 505-b may perform a physical uplink shared channel (PUSCH) transport process. The device 505-b may use the triangular interleaver during mapping from VRB to PRB in the PUSCH transport process. In examples in which the device 505-b generates the TB and uses the triangular interleaver, the device 505-a may deinterleave the TB generated by the device 505-b according to a triangular matrix. That is, the device 505-a may deinterleave a set of PRBs to a set of VRBs according to a reverse read-write order from the interleaving operation performed at the device 505-a.

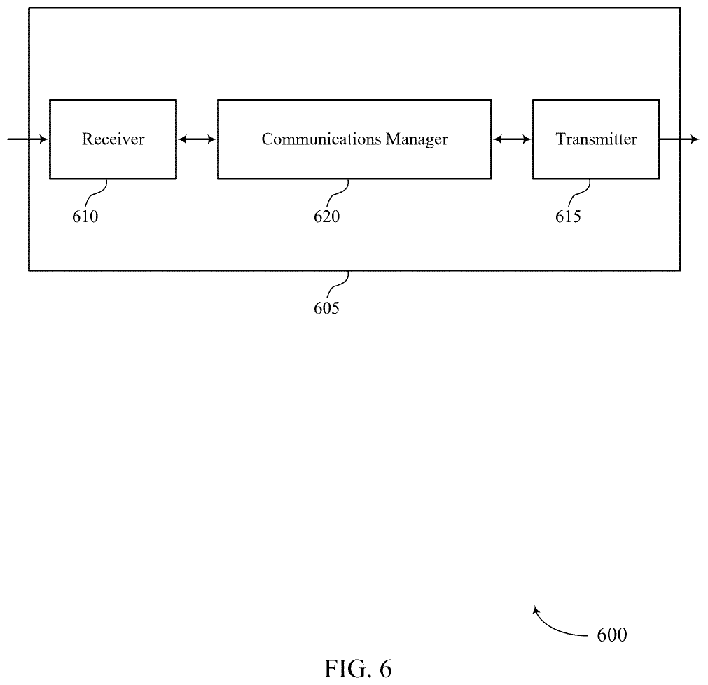

FIG. 6 shows a block diagram 600 of a device 605 that supports triangular interleaver for frequency domain diversity in accordance with one or more aspects of the present disclosure. The device 605 may be an example of aspects of a network entity 105 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 605. In some examples, the receiver 610 may support obtaining information by receiving signals via one or more antennas. Additionally, or alternatively, the receiver 610 may support obtaining information by receiving signals via one or more wired (e.g., electrical, fiber optic) interfaces, wireless interfaces, or any combination thereof.

The transmitter 615 may provide a means for outputting (e.g., transmitting, providing, conveying, sending) information generated by other components of the device 605. For example, the transmitter 615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 615 may support outputting information by transmitting signals via one or more antennas. Additionally, or alternatively, the transmitter 615 may support outputting information by transmitting signals via one or more wired (e.g., electrical, fiber optic) interfaces, wireless interfaces, or any combination thereof. In some examples, the transmitter 615 and the receiver 610 may be co-located in a transceiver, which may include or be coupled with a modem.

The communications manager 620, the receiver 610, the transmitter 615, or various combinations or components thereof may be examples of means for performing various aspects of triangular interleaver for frequency domain diversity as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for generating a TB including a set of multiple symbols, the set of multiple symbols including modulated and precoded symbols. The communications manager 620 is capable of, configured to, or operable to support a means for interleaving a first set of resource blocks to a second set of resource blocks in a frequency domain by mapping the first set of resource blocks to the second set of resource blocks according to a triangular matrix for one or more of the set of multiple symbols, where the first set of resource blocks includes one or more VRBs, and where the second set of resource blocks includes one or more PRBs. The communications manager 620 is capable of, configured to, or operable to support a means for transmitting the TB based on the interleaving.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for more efficient utilization of communication resources.

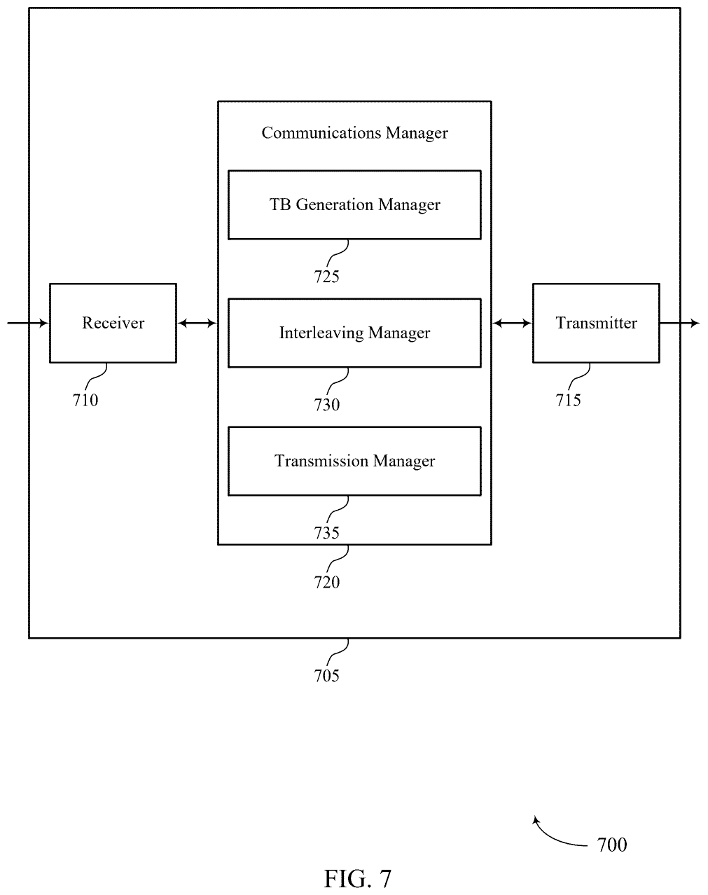

FIG. 7 shows a block diagram 700 of a device 705 that supports triangular interleaver for frequency domain diversity in accordance with one or more aspects of the present disclosure. The device 705 may be an example of aspects of a device 605 or a network entity 105 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 705. In some examples, the receiver 710 may support obtaining information by receiving signals via one or more antennas. Additionally, or alternatively, the receiver 710 may support obtaining information by receiving signals via one or more wired (e.g., electrical, fiber optic) interfaces, wireless interfaces, or any combination thereof.

The transmitter 715 may provide a means for outputting (e.g., transmitting, providing, conveying, sending) information generated by other components of the device 705. For example, the transmitter 715 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 715 may support outputting information by transmitting signals via one or more antennas. Additionally, or alternatively, the transmitter 715 may support outputting information by transmitting signals via one or more wired (e.g., electrical, fiber optic) interfaces, wireless interfaces, or any combination thereof. In some examples, the transmitter 715 and the receiver 710 may be co-located in a transceiver, which may include or be coupled with a modem.

The device 705, or various components thereof, may be an example of means for performing various aspects of triangular interleaver for frequency domain diversity as described herein. For example, the communications manager 720 may include a TB generation manager 725, an interleaving manager 730, a transmission manager 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The TB generation manager 725 is capable of, configured to, or operable to support a means for generating a TB including a set of multiple symbols, the set of multiple symbols including modulated and precoded symbols. The interleaving manager 730 is capable of, configured to, or operable to support a means for interleaving a first set of resource blocks to a second set of resource blocks in a frequency domain by mapping the first set of resource blocks to the second set of resource blocks according to a triangular matrix for one or more of the set of multiple symbols, where the first set of resource blocks includes one or more VRBs, and where the second set of resource blocks includes one or more PRBs. The transmission manager 735 is capable of, configured to, or operable to support a means for transmitting the TB based on the interleaving.

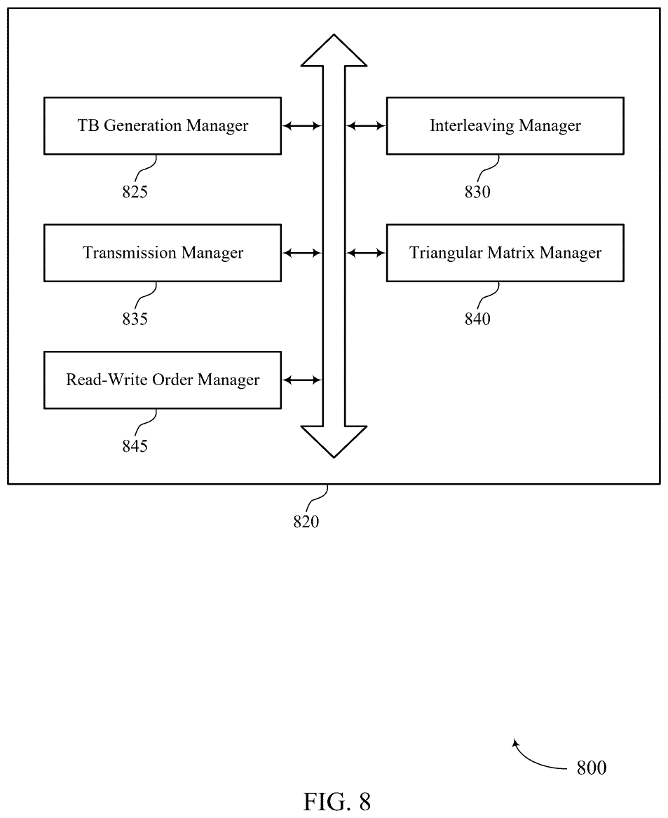

FIG. 8 shows a block diagram 800 of a communications manager 820 that supports triangular interleaver for frequency domain diversity in accordance with one or more aspects of the present disclosure. The communications manager 820 may be an example of aspects of a communications manager 620, a communications manager 720, or both, as described herein. The communications manager 820, or various components thereof, may be an example of means for performing various aspects of triangular interleaver for frequency domain diversity as described herein. For example, the communications manager 820 may include a TB generation manager 825, an interleaving manager 830, a transmission manager 835, a triangular matrix manager 840, a read-write order manager 845, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 820 may support wireless communications in accordance with examples as disclosed herein. The TB generation manager 825 is capable of, configured to, or operable to support a means for generating a TB including a set of multiple symbols, the set of multiple symbols including modulated and precoded symbols. The interleaving manager 830 is capable of, configured to, or operable to support a means for interleaving a first set of resource blocks to a second set of resource blocks in a frequency domain by mapping the first set of resource blocks to the second set of resource blocks according to a triangular matrix for one or more of the set of multiple symbols, where the first set of resource blocks includes one or more VRBs, and where the second set of resource blocks includes one or more PRBs. The transmission manager 835 is capable of, configured to, or operable to support a means for transmitting the TB based on the interleaving.

In some examples, a first resource block in a first row of a set of multiple rows of the second set of resource blocks is offset from a second resource block adjacent to the first resource block in the first row by a first quantity of resource blocks, and the second resource block in the first row is offset from a third resource block adjacent to the second resource block in the first row by a second quantity of resource blocks, where the first quantity of resource blocks is different from the second quantity of resource blocks.

In some examples, one or more first rows of a set of multiple rows of the triangular matrix are associated with a first length, and one or more second rows of the set of multiple rows of the triangular matrix are associated with a second length different from the first length.

In some examples, to support interleaving the first set of resource blocks to the second set of resource blocks, the interleaving manager 830 is capable of, configured to, or operable to support a means for interleaving the first set of resource blocks to the second set of resource blocks according to the triangular matrix and a write-read order.

In some examples, the triangular matrix is associated with an orientation, the orientation indicative of a direction of a diagonal edge of the triangular matrix.

In some examples, the orientation is associated with a write-read order, a read-write order, or both.

In some examples, the triangular matrix manager 840 is capable of, configured to, or operable to support a means for selecting a length of the triangular matrix, where the length satisfies a threshold quantity of resource blocks according to a first equation, the threshold quantity of resource blocks based on the second set of resource blocks. In some examples, the triangular matrix manager 840 is capable of, configured to, or operable to support a means for selecting a width of the triangular matrix, where the width satisfies the threshold quantity of resource blocks according to a second equation, and where the triangular matrix is geometrically defined via the selected length and the selected width.

In some examples, the read-write order manager 845 is capable of, configured to, or operable to support a means for transmitting a message indicating a read-write order associated with the TB based on the triangular matrix, the read-write order associated with a diagonal alignment of the triangular matrix.

In some examples, the triangular matrix manager 840 is capable of, configured to, or operable to support a means for transmitting a message indicating that the triangular matrix is used to interleave the first set of resource blocks to the second set of resource blocks in the frequency domain for one or more symbols of a set of multiple symbols including the TB.

In some examples, the message includes one of a DCI message or an RRC message.

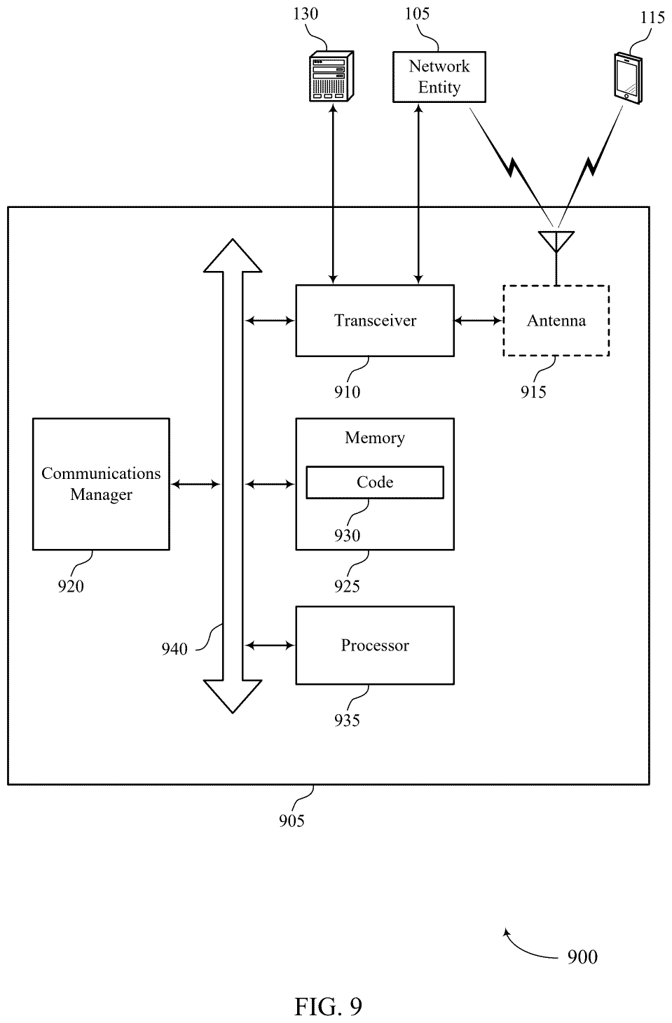

FIG. 9 shows a diagram of a system 900 including a device 905 that supports triangular interleaver for frequency domain diversity in accordance with one or more aspects of the present disclosure. The device 905 may be an example of or include components of a device 605, a device 705, or a network entity 105 as described herein. The device 905 may communicate with other network devices or network equipment such as one or more of the network entities 105, UEs 115, or any combination thereof. The communications may include communications over one or more wired interfaces, over one or more wireless interfaces, or any combination thereof. The device 905 may include components that support outputting and obtaining communications, such as a communications manager 920, a transceiver 910, one or more antennas 915, at least one memory 925, code 930, and at least one processor 935. These components may be in electronic communication or otherwise coupled (e.g., operatively, communicatively, functionally, electronically, electrically) via one or more buses (e.g., a bus 940).

The transceiver 910 may support bi-directional communications via wired links, wireless links, or both as described herein. In some examples, the transceiver 910 may include a wired transceiver and may communicate bi-directionally with another wired transceiver. Additionally, or alternatively, in some examples, the transceiver 910 may include a wireless transceiver and may communicate bi-directionally with another wireless transceiver. In some examples, the device 905 may include one or more antennas 915, which may be capable of transmitting or receiving wireless transmissions (e.g., concurrently). The transceiver 910 may also include a modem to modulate signals, to provide the modulated signals for transmission (e.g., by one or more antennas 915, by a wired transmitter), to receive modulated signals (e.g., from one or more antennas 915, from a wired receiver), and to demodulate signals. In some implementations, the transceiver 910 may include one or more interfaces, such as one or more interfaces coupled with the one or more antennas 915 that are configured to support various receiving or obtaining operations, or one or more interfaces coupled with the one or more antennas 915 that are configured to support various transmitting or outputting operations, or a combination thereof. In some implementations, the transceiver 910 may include or be configured for coupling with one or more processors or one or more memory components that are operable to perform or support operations based on received or obtained information or signals, or to generate information or other signals for transmission or other outputting, or any combination thereof. In some implementations, the transceiver 910, or the transceiver 910 and the one or more antennas 915, or the transceiver 910 and the one or more antennas 915 and one or more processors or one or more memory components (e.g., the at least one processor 935, the at least one memory 925, or both), may be included in a chip or chip assembly that is installed in the device 905. In some examples, the transceiver 910 may be operable to support communications via one or more communications links (e.g., communication link(s) 125, backhaul communication link(s) 120, a midhaul communication link 162, a fronthaul communication link 168).

The at least one memory 925 may include RAM, ROM, or any combination thereof. The at least one memory 925 may store computer-readable, computer-executable, or processor-executable code, such as the code 930. The code 930 may include instructions that, when executed by one or more of the at least one processor 935, cause the device 905 to perform various functions described herein. The code 930 may be stored in a non-transitory computer-readable medium such as system memory or another type of memory. In some cases, the code 930 may not be directly executable by a processor of the at least one processor 935 but may cause a computer (e.g., when compiled and executed) to perform functions described herein. In some cases, the at least one memory 925 may include, among other things, a BIOS which may control basic hardware or software operation such as the interaction with peripheral components or devices. In some examples, the at least one processor 935 may include multiple processors and the at least one memory 925 may include multiple memories. One or more of the multiple processors may be coupled with one or more of the multiple memories which may, individually or collectively, be configured to perform various functions herein (for example, as part of a processing system).

The at least one processor 935 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 935 may be configured to operate a memory array using a memory controller. In some other cases, a memory controller may be integrated into one or more of the at least one processor 935. The at least one processor 935 may be configured to execute computer-readable instructions stored in a memory (e.g., one or more of the at least one memory 925) to cause the device 905 to perform various functions (e.g., functions or tasks supporting triangular interleaver for frequency domain diversity). For example, the device 905 or a component of the device 905 may include at least one processor 935 and at least one memory 925 coupled with one or more of the at least one processor 935, the at least one processor 935 and the at least one memory 925 configured to perform various functions described herein. The at least one processor 935 may be an example of a cloud-computing platform (e.g., one or more physical nodes and supporting software such as operating systems, virtual machines, or container instances) that may host the functions (e.g., by executing code 930) to perform the functions of the device 905. The at least one processor 935 may be any one or more suitable processors capable of executing scripts or instructions of one or more software programs stored in the device 905 (such as within one or more of the at least one memory 925).

In some examples, the at least one processor 935 may include multiple processors and the at least one memory 925 may include multiple memories. One or more of the multiple processors may be coupled with one or more of the multiple memories, which may, individually or collectively, be configured to perform various functions herein. In some examples, the at least one processor 935 may be a component of a processing system, which may refer to a system (such as a series) of machines, circuitry (including, for example, one or both of processor circuitry (which may include the at least one processor 935) and memory circuitry (which may include the at least one memory 925)), or components, that receives or obtains inputs and processes the inputs to produce, generate, or obtain a set of outputs. The processing system may be configured to perform one or more of the functions described herein. For example, the at least one processor 935 or a processing system including the at least one processor 935 may be configured to, configurable to, or operable to cause the device 905 to perform one or more of the functions described herein. Further, as described herein, being “configured to,” being “configurable to,” and being “operable to” may be used interchangeably and may be associated with a capability, when executing code stored in the at least one memory 925 or otherwise, to perform one or more of the functions described herein.

In some examples, a bus 940 may support communications of (e.g., within) a protocol layer of a protocol stack. In some examples, a bus 940 may support communications associated with a logical channel of a protocol stack (e.g., between protocol layers of a protocol stack), which may include communications performed within a component of the device 905, or between different components of the device 905 that may be co-located or located in different locations (e.g., where the device 905 may refer to a system in which one or more of the communications manager 920, the transceiver 910, the at least one memory 925, the code 930, and the at least one processor 935 may be located in one of the different components or divided between different components).

In some examples, the communications manager 920 may manage aspects of communications with a core network 130 (e.g., via one or more wired or wireless backhaul links). For example, the communications manager 920 may manage the transfer of data communications for client devices, such as one or more UEs 115. In some examples, the communications manager 920 may manage communications with one or more other network entities 105, and may include a controller or scheduler for controlling communications with UEs 115 (e.g., in cooperation with the one or more other network devices). In some examples, the communications manager 920 may support an X2 interface within an LTE/LTE-A wireless communications network technology to provide communication between network entities 105.

The communications manager 920 may support wireless communications in accordance with examples as disclosed herein. For example, the communications manager 920 is capable of, configured to, or operable to support a means for generating a TB including a set of multiple symbols, the set of multiple symbols including modulated and precoded symbols. The communications manager 920 is capable of, configured to, or operable to support a means for interleaving a first set of resource blocks to a second set of resource blocks in a frequency domain by mapping the first set of resource blocks to the second set of resource blocks according to a triangular matrix for one or more of the set of multiple symbols, where the first set of resource blocks includes one or more VRBs, and where the second set of resource blocks includes one or more PRBs. The communications manager 920 is capable of, configured to, or operable to support a means for transmitting the TB based on the interleaving.

By including or configuring the communications manager 920 in accordance with examples as described herein, the device 905 may support techniques for more efficient utilization of communication resources, improved coordination between devices, and improved utilization of processing capability.

In some examples, the communications manager 920 may be configured to perform various operations (e.g., receiving, obtaining, monitoring, outputting, transmitting) using or otherwise in cooperation with the transceiver 910, the one or more antennas 915 (e.g., where applicable), or any combination thereof. Although the communications manager 920 is illustrated as a separate component, in some examples, one or more functions described with reference to the communications manager 920 may be supported by or performed by the transceiver 910, one or more of the at least one processor 935, one or more of the at least one memory 925, the code 930, or any combination thereof (for example, by a processing system including at least a portion of the at least one processor 935, the at least one memory 925, the code 930, or any combination thereof). For example, the code 930 may include instructions executable by one or more of the at least one processor 935 to cause the device 905 to perform various aspects of triangular interleaver for frequency domain diversity as described herein, or the at least one processor 935 and the at least one memory 925 may be otherwise configured to, individually or collectively, perform or support such operations.

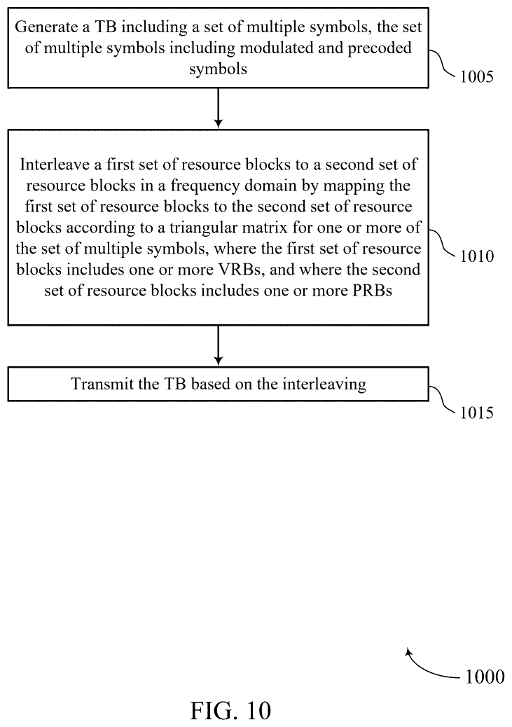

FIG. 10 shows a flowchart illustrating a method 1000 that supports triangular interleaver for frequency domain diversity in accordance with one or more aspects of the present disclosure. The operations of the method 1000 may be implemented by a network entity or its components as described herein. For example, the operations of the method 1000 may be performed by a network entity as described with reference to FIGS. 1 through 9. In some examples, a network entity may execute a set of instructions to control the functional elements of the network entity to perform the described functions. Additionally, or alternatively, the network entity may perform aspects of the described functions using special-purpose hardware.

At 1005, the method may include generating a TB including a set of multiple symbols, the set of multiple symbols including modulated and precoded symbols. The operations of 1005 may be performed in accordance with examples as disclosed herein. In some examples, aspects of the operations of 1005 may be performed by a TB generation manager 825 as described with reference to FIG. 8.

At 1010, the method may include interleaving a first set of resource blocks to a second set of resource blocks in a frequency domain by mapping the first set of resource blocks to the second set of resource blocks according to a triangular matrix for one or more of the set of multiple symbols, where the first set of resource blocks includes one or more VRBs, and where the second set of resource blocks includes one or more PRBs. The operations of 1010 may be performed in accordance with examples as disclosed herein. In some examples, aspects of the operations of 1010 may be performed by an interleaving manager 830 as described with reference to FIG. 8.

At 1015, the method may include transmitting the TB based on the interleaving. The operations of 1015 may be performed in accordance with examples as disclosed herein. In some examples, aspects of the operations of 1015 may be performed by a transmission manager 835 as described with reference to FIG. 8.

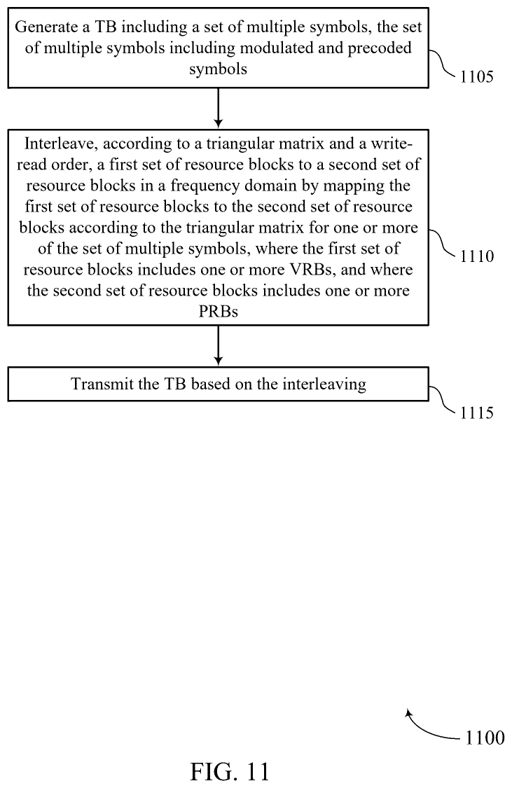

FIG. 11 shows a flowchart illustrating a method 1100 that supports triangular interleaver for frequency domain diversity in accordance with one or more aspects of the present disclosure. The operations of the method 1100 may be implemented by a network entity or its components as described herein. For example, the operations of the method 1100 may be performed by a network entity as described with reference to FIGS. 1 through 9. In some examples, a network entity may execute a set of instructions to control the functional elements of the network entity to perform the described functions. Additionally, or alternatively, the network entity may perform aspects of the described functions using special-purpose hardware.

At 1105, the method may include generating a TB including a set of multiple symbols, the set of multiple symbols including modulated and precoded symbols. The operations of 1105 may be performed in accordance with examples as disclosed herein.

In some examples, aspects of the operations of 1105 may be performed by a TB generation manager 825 as described with reference to FIG. 8.

At 1110, the method may include interleaving a first set of resource blocks to a second set of resource blocks in a frequency domain by mapping the first set of resource blocks to the second set of resource blocks according to a triangular matrix for one or more of the set of multiple symbols, where the first set of resource blocks includes one or more VRBs, and where the second set of resource blocks includes one or more PRBs. The operations of 1110 may be performed in accordance with examples as disclosed herein. In some examples, aspects of the operations of 1110 may be performed by an interleaving manager 830 as described with reference to FIG. 8.

At 1115, the method may include transmitting the TB based on the interleaving. The operations of 1115 may be performed in accordance with examples as disclosed herein. In some examples, aspects of the operations of 1115 may be performed by a transmission manager 835 as described with reference to FIG. 8.

At 1120, the method may include interleaving the first set of resource blocks to the second set of resource blocks according to the triangular matrix and a write-read order. The operations of 1120 may be performed in accordance with examples as disclosed herein. In some examples, aspects of the operations of 1120 may be performed by an interleaving manager 830 as described with reference to FIG. 8.

The following provides an overview of aspects of the present disclosure:

Aspect 1: A method for wireless communications at a wireless communication device, comprising: generating a TB comprising a plurality of symbols, the plurality of symbols comprising modulated and precoded symbols; interleaving a first set of resource blocks to a second set of resource blocks in a frequency domain by mapping the first set of resource blocks to the second set of resource blocks according to a triangular matrix for one or more of the plurality of symbols, wherein the first set of resource blocks comprises one or more VRBs, and wherein the second set of resource blocks comprises one or more PRBs; and transmitting the TB based at least in part on the interleaving.

Aspect 2: The method of aspect 1, wherein, in accordance with the interleaving associated with the triangular matrix a first resource block in a first row of a plurality of rows of the second set of resource blocks is offset from a second resource block adjacent to the first resource block in the first row by a first quantity of resource blocks, and the second resource block in the first row is offset from a third resource block adjacent to the second resource block in the first row by a second quantity of resource blocks, wherein the first quantity of resource blocks is different from the second quantity of resource blocks.

Aspect 3: The method of any of aspects 1 through 2, wherein one or more first rows of a plurality of rows of the triangular matrix are associated with a first length, and one or more second rows of the plurality of rows of the triangular matrix are associated with a second length different from the first length.

Aspect 4: The method of any of aspects 1 through 3, wherein interleaving the first set of resource blocks to the second set of resource blocks further comprises: interleaving the first set of resource blocks to the second set of resource blocks according to the triangular matrix and a write-read order.

Aspect 5: The method of any of aspects 1 through 4, wherein the triangular matrix is associated with an orientation, the orientation indicative of a direction of a diagonal edge of the triangular matrix.

Aspect 6: The method of aspect 5, wherein the orientation is associated with a write-read order, a read-write order, or both.

Aspect 7: The method of any of aspects 1 through 6, further comprising: selecting a length of the triangular matrix, wherein the length satisfies a threshold quantity of resource blocks according to a first equation, the threshold quantity of resource blocks based at least in part on the second set of resource blocks; and selecting a width of the triangular matrix, wherein the width satisfies the threshold quantity of resource blocks according to a second equation, and wherein the triangular matrix is geometrically defined via the selected length and the selected width.

Aspect 8: The method of any of aspects 1 through 7, further comprising: transmitting a message indicating a read-write order associated with the TB based at least in part on the triangular matrix, the read-write order associated with a diagonal alignment of the triangular matrix.

Aspect 9: The method of any of aspects 1 through 8, further comprising: transmitting a message indicating that the triangular matrix is used to interleave the first set of resource blocks to the second set of resource blocks in the frequency domain for one or more symbols of a plurality of symbols comprising the TB.

Aspect 10: The method of aspect 9, wherein the message comprises one of a DCI message or an RRC message.

Aspect 11: A wireless communication device for wireless communications, comprising one or more memories storing processor-executable code, and one or more processors coupled with the one or more memories and individually or collectively operable to execute the code to cause the wireless communication device to perform a method of any of aspects 1 through 10.

Aspect 12: A wireless communication device for wireless communications, comprising at least one means for performing a method of any of aspects 1 through 10.

Aspect 13: A non-transitory computer-readable medium storing code for wireless communications, the code comprising instructions executable by one or more processors to perform a method of any of aspects 1 through 10.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A device, comprising:
one or more memories storing processor-executable code; and
one or more processors coupled with the one or more memories and individually or collectively operable to execute the code to cause the device to:
generate a transport block comprising a plurality of symbols, the plurality of symbols comprising modulated and precoded symbols;
interleave a first set of resource blocks to a second set of resource blocks in a frequency domain by mapping the first set of resource blocks to the second set of resource blocks according to a triangular matrix for one or more of the plurality of symbols, wherein the first set of resource blocks comprises one or more virtual resource blocks, and wherein the second set of resource blocks comprises one or more physical resource blocks; and
transmit the transport block based at least in part on the interleaving.

2. The device of claim 1, wherein a first resource block in a first row of a plurality of rows of the second set of resource blocks is offset from a second resource block adjacent to the first resource block in the first row by a first quantity of resource blocks, and the second resource block in the first row is offset from a third resource block adjacent to the second resource block in the first row by a second quantity of resource blocks, wherein the first quantity of resource blocks is different from the second quantity of resource blocks.

3. The device of claim 1, wherein one or more first rows of a plurality of rows of the triangular matrix are associated with a first length, and one or more second rows of the plurality of rows of the triangular matrix are associated with a second length different from the first length.

4. The device of claim 1, wherein, to interleave the first set of resource blocks to the second set of resource blocks, the one or more processors are individually or collectively further operable to execute the code to cause the device to:
interleave the first set of resource blocks to the second set of resource blocks according to the triangular matrix and a write-read order.

5. The device of claim 1, wherein the triangular matrix is associated with an orientation, the orientation indicative of a direction of a diagonal edge of the triangular matrix.

6. The device of claim 5, wherein the orientation is associated with a write-read order, a read-write order, or both.

7. The device of claim 1, wherein the one or more processors are individually or collectively further operable to execute the code to cause the device to:
select a length of the triangular matrix, wherein the length satisfies a threshold quantity of resource blocks according to a first equation, the threshold quantity of resource blocks based at least in part on the second set of resource blocks; and
select a width of the triangular matrix, wherein the width satisfies the threshold quantity of resource blocks according to a second equation, and wherein the triangular matrix is geometrically defined via the selected length and the selected width.

8. The device of claim 1, wherein the one or more processors are individually or collectively further operable to execute the code to cause the device to:
transmit a message indicating a read-write order associated with the transport block based at least in part on the triangular matrix, the read-write order associated with a diagonal alignment of the triangular matrix.

9. The device of claim 1, wherein the one or more processors are individually or collectively further operable to execute the code to cause the device to:
transmit a message indicating that the triangular matrix is used to interleave the first set of resource blocks to the second set of resource blocks in the frequency domain for one or more symbols of the plurality of symbols of the transport block.

10. The device of claim 9, wherein the message comprises one of a downlink control information (DCI) message or a radio resource control (RRC) message.

11. A method for wireless communications at a device, comprising:
generating a transport block comprising a plurality of symbols, the plurality of symbols comprising modulated and precoded symbols;
interleaving a first set of resource blocks to a second set of resource blocks in a frequency domain by mapping the first set of resource blocks to the second set of resource blocks according to a triangular matrix for one or more of the plurality of symbols, wherein the first set of resource blocks comprises one or more virtual resource blocks, and wherein the second set of resource blocks comprises one or more physical resource blocks; and
transmitting the transport block based at least in part on the interleaving.

12. The method of claim 11, wherein, in accordance with the interleaving associated with the triangular matrix a first resource block in a first row of a plurality of rows of the second set of resource blocks is offset from a second resource block adjacent to the first resource block in the first row by a first quantity of resource blocks, and the second resource block in the first row is offset from a third resource block adjacent to the second resource block in the first row by a second quantity of resource blocks, wherein the first quantity of resource blocks is different from the second quantity of resource blocks.

13. The method of claim 11, wherein one or more first rows of a plurality of rows of the triangular matrix are associated with a first length, and one or more second rows of the plurality of rows of the triangular matrix are associated with a second length different from the first length.

14. The method of claim 11, wherein interleaving the first set of resource blocks to the second set of resource blocks further comprises:
interleaving the first set of resource blocks to the second set of resource blocks according to the triangular matrix and a write-read order.

15. The method of claim 11, wherein the triangular matrix is associated with an orientation, the orientation indicative of a direction of a diagonal edge of the triangular matrix.

16. The method of claim 15, wherein the orientation is associated with a write-read order, a read-write order, or both.

17. The method of claim 11, further comprising:
selecting a length of the triangular matrix, wherein the length satisfies a threshold quantity of resource blocks according to a first equation, the threshold quantity of resource blocks based at least in part on the second set of resource blocks; and
selecting a width of the triangular matrix, wherein the width satisfies the threshold quantity of resource blocks according to a second equation, and wherein the triangular matrix is geometrically defined via the selected length and the selected width.

18. The method of claim 11, further comprising:
transmitting a message indicating a read-write order associated with the transport block based at least in part on the triangular matrix, the read-write order associated with a diagonal alignment of the triangular matrix.

19. A non-transitory computer-readable medium storing code for wireless communications, the code comprising instructions executable by one or more processors to:
generate a transport block comprising a plurality of symbols, the plurality of symbols comprising modulated and precoded symbols;
interleave a first set of resource blocks to a second set of resource blocks in a frequency domain by mapping the first set of resource blocks to the second set of resource blocks according to a triangular matrix for one or more of the plurality of symbols, wherein the first set of resource blocks comprises one or more virtual resource blocks, and wherein the second set of resource blocks comprises one or more physical resource blocks; and
transmit the transport block based at least in part on the interleaving.

20. The non-transitory computer-readable medium of claim 19, wherein a first resource block in a first row of a plurality of rows of the second set of resource blocks is offset from a second resource block adjacent to the first resource block in the first row by a first quantity of resource blocks, and the second resource block in the first row is offset from a third resource block adjacent to the second resource block in the first row by a second quantity of resource blocks, wherein the first quantity of resource blocks is different from the second quantity of resource blocks.
